(19) United States
(12) Patent Application Publication
(10) Pub. No.: US 2015/0022830 A1
(43) Pub. Date: Jan. 22, 2015

(54) IMAGE FORMING APPARATUS AND METHOD OF CONTROLLING THE SAME

(71) Applicant: Samsung Electronics Co., Ltd., Suwon-si (KR)

(72) Inventors: Eun Bit KWAK, Seoul (KR); Jung Han KIM, Suwon-si (KR); Gyu Sok JUN, Seoul (KR)

(73) Assignee: SAMSUNG ELECTRONICS CO., LTD., Suwon-si (KR)

(21) Appl. No.: 14/312,992

(22) Filed: Jun. 24, 2014

(30) Foreign Application Priority Data
Jul. 17, 2013 (KR) 10-2013-0084342

(51) Int. Cl. G06K 15/02; H04N 1/00; G06F 3/12

(52) U.S. Cl. CPC G06K 15/021; G06F 3/1219; G06F 3/1204; G06F 3/1208; H04N 1/0044
USPC 358/1.6

(57) ABSTRACT

Disclosed herein are an image forming apparatus and a method of controlling the same. The method provides a preview picture color-calibrated depending on a color of a printing medium in an image forming apparatus which prints an image on the printing medium. The method includes receiving image data which is to be printed, receiving color information of a printing medium which is to be used in printing of the image data, and performing a first color calibration on the image data, reflecting the color information of the printing medium.

### CROSS-REFERENCE TO RELATED APPLICATIONS

This application claims the priority benefit of Korean Patent Application No. 10-2013-0084342, filed on Jul. 17, 2013 in the Korean Intellectual Property Office, the disclosure of which is incorporated herein by reference.

### BACKGROUND

1. Field

Embodiments relate to an image forming apparatus. More specifically, embodiments relate to an image forming apparatus including a scanning unit for scanning a document to generate an image of the document. Here, the image forming apparatus may be a scanner, a multi-function apparatus including a scanning unit, or a printer having a scan function.

2. Description of the Related Art

An image forming apparatus configured to print an image on a printing medium supports various types of printing media. For example, various types of printing media that have various thicknesses, materials, or colors, may be used.

In color printing media among the printing media, due to interference between a color of the printing medium and a color of an image to be printed on the printing medium (in case of a color image), an original color of the image may not be fully printed. In particular, a “preview” which shows a printed result on a display before the image is printed on the printing medium, implements a preview picture based on white printing media. Accordingly, the preview picture may be different from the result printed on a real printing medium when the printing medium is a color printing medium, resulting in confusion of the user, duplication of printing jobs, and waste of printing media.

### SUMMARY

In an aspect of one or more embodiments, there is provided a preview picture color-calibrated depending on a color of a printing medium on which an image is printed, in an image forming apparatus.

In an aspect of one or more embodiments, there is provided a method of controlling an image forming apparatus which includes receiving image data which is to be printed, receiving color information of a printing medium which is to be used in printing of the image data, and performing a first color calibration on the image data reflecting the color information of the printing medium.

The method may further include displaying a preview picture of the color-calibrated image data on a display.

The method may further include displaying a user interface for receiving the color information of the printing medium on a display.

The user interface may display a user display including a plurality of color samples on the display, in order for a user to select a color corresponding to a color of the printing medium.

The user interface may display a unique identification code of at least one printing medium, and a corresponding color on the display.

When the at least one printing medium is selected, the preview picture may be generated in consideration of whiteness data of the at least one printing medium. The whiteness data of the at least one printing medium may have been stored in the image forming apparatus.

The method may further include obtaining the whiteness data of the at least one printing medium in advance, to be stored in the image forming apparatus.

The method may further include receiving the whiteness data of the at least one printing medium from the user, to be stored in the image forming apparatus.

The whiteness data of the at least one printing medium may be obtained by pre-scanning the at least one printing medium.

The method may further include converting a color space of the image data to a color space of a printing unit by which an image is to be formed on the printing medium, reflecting the whiteness data.

The method may further include displaying a user display including at least one color calibration option on the display, and allowing a user to perform a second color calibration on the image data shown in the preview picture by directly adjusting a value of the at least one color calibration option.

The color calibration option of the user display may include an option of controlling three primary colors consisting of red (R), green (G), and blue (B).

In an aspect of one or more embodiments, there is provided an image forming apparatus which includes an input device receiving color information of a printing medium which is to be used in printing of image data, and a controller performing a first color calibration on the image data, reflecting the color information of the printing medium which is received from the input device.

The image forming apparatus may further include a display displaying a preview picture of the color-calibrated image data.

The input device may be a display displaying a user interface for receiving the color information of the printing medium.

The user interface may display a user display including a plurality of color samples on the display, in order for a user to select a color corresponding to a color of the printing medium.

The user interface may display a unique identification code of at least one printing medium, and a corresponding color on the display.

When the at least one printing medium is selected, the preview picture may be generated reflecting whiteness data of the at least one printing medium.

The whiteness data of the at least one printing medium may be obtained by pre-scanning the at least one printing medium.

The image forming apparatus may further include obtaining the whiteness data of the at least one printing medium in advance, to be stored in the image forming apparatus.

The image forming apparatus may further include receiving the whiteness data of the at least one printing medium from a user, to be stored in the image forming apparatus.

The image forming apparatus may further include converting a color space of the image data to a color space of a printing unit by which an image is to be formed on the printing medium, reflecting the whiteness data.

The image forming apparatus may further include displaying a user display including at least one color calibration option on the display, and allowing a user to perform a second color calibration on the image data shown in the preview picture by directly adjusting a value of the at least one color calibration option.

The color calibration option of the user display may include an option of controlling three primary colors consisting of red (R), green (G), and blue (B).

In an aspect of one or more embodiments, there is provided a method of controlling an image forming apparatus which includes receiving image data which is to be printed, displaying a user interface including a plurality of color samples on a display, in order for a user to select a color corresponding to a color of a printing medium, receiving color information of the printing medium which is to be used in printing of the image data through the user interface, and performing a first color calibration on the image data, reflecting the color information of the printing medium.

The method may further include displaying a preview picture of the color-calibrated image data on the display.

The method may further include displaying the user interface for receiving the color information of the printing medium on the display.

The method may further include displaying a user interface including at least one color calibration option on the display, and allowing the user to directly perform a second color calibration on the image data shown in the preview picture by directly adjusting a value of the at least one color calibration option.

In an aspect of one or more embodiments, there is provided a method of controlling an image forming apparatus includes obtaining whiteness data of at least one printing medium by scanning the at least one printing medium, storing interrelationships of a unique identification code of the at least one printing medium, a corresponding color, and whiteness data, receiving image data which is to be printed, receiving color information of the printing medium which is to be used in printing of the image data, through selection of the unique identification code of the at least one printing medium, converting a color space of the image data to a color space of a printing unit by which an image is to be formed on the printing medium, reflecting the obtained whiteness data of the at least one printing medium, and performing a first color calibration on the image data, reflecting the converted color space.

The method may further include displaying a preview picture of the color-calibrated image data on a display.

The method may further include displaying a user interface for receiving the color information of the printing medium on a display.

The method may further include displaying a user interface including at least one color calibration option on a display, and allowing a user to directly perform a second color calibration on the image data shown in the preview picture by directly adjusting a value of the at least one color calibration option.

The method may further include obtaining the whiteness data of the at least one printing medium in advance, to be stored in the image forming apparatus.

The method may further include receiving the whiteness data of the at least one printing medium from a user, to be stored in the image forming apparatus.

### BRIEF DESCRIPTION OF THE DRAWINGS

These and/or other aspects will become apparent and more readily appreciated from the following description of embodiments, taken in conjunction with the accompanying drawings of which:

FIG. 1 is a perspective view of an image forming apparatus in accordance with an embodiment;

FIG. 2 is a front view of an image forming apparatus in accordance with an embodiment;

FIG. 3 is a side view of an image forming apparatus in accordance with an embodiment;

FIG. 4 is a schematic diagram showing a control system of an image forming apparatus in accordance with an embodiment;

FIG. 5 is a diagram showing a first embodiment of a control method of generating a preview picture, reflecting a printing media color, in an image forming apparatus in accordance with an embodiment;

FIGS. 6A-6C are diagrams showing user interfaces (UIs) displayed on a display while performing the control method of FIG. 5;

FIG. 7 is a diagram showing a method of obtaining whiteness in an image forming apparatus in accordance with an embodiment;

FIG. 8 is a diagram showing a second embodiment of a control method of generating a preview picture, reflecting a printing media color, in an image forming apparatus in accordance with an embodiment;

FIGS. 9A-9C are diagrams showing user interfaces UIs displayed on a display while performing the control method of FIG. 8; and

FIG. 10 is a diagram showing another method of receiving image data in an image forming apparatus in accordance with an embodiment.

### DETAILED DESCRIPTION

Reference will now be made in detail to embodiments, examples of which are illustrated in the accompanying drawings, wherein like reference numerals refer to like elements throughout.

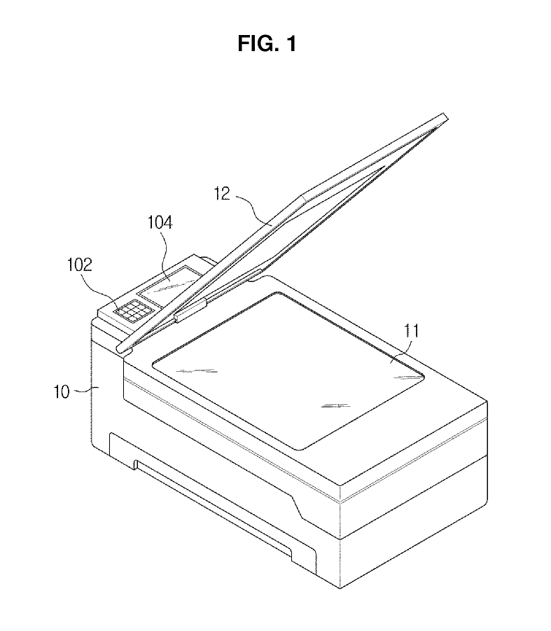

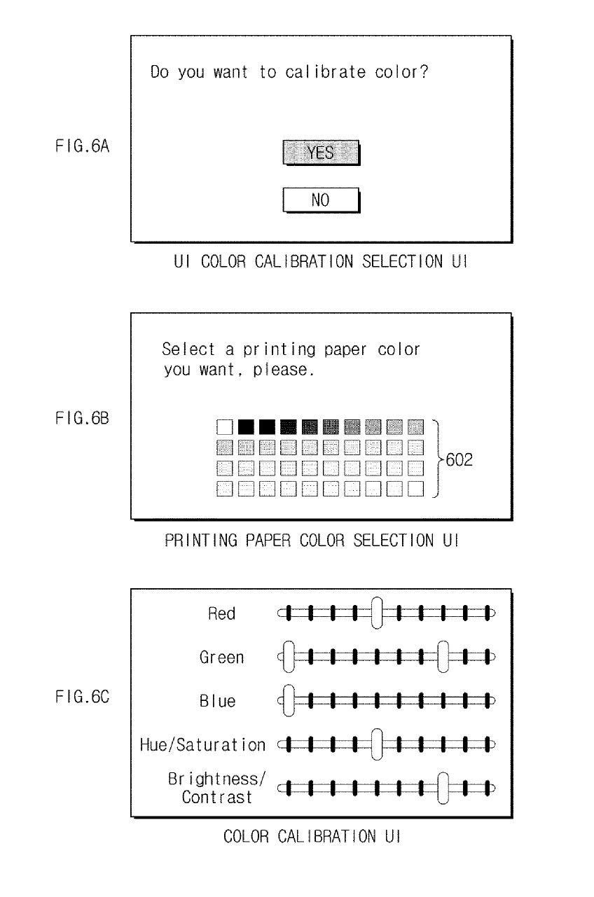

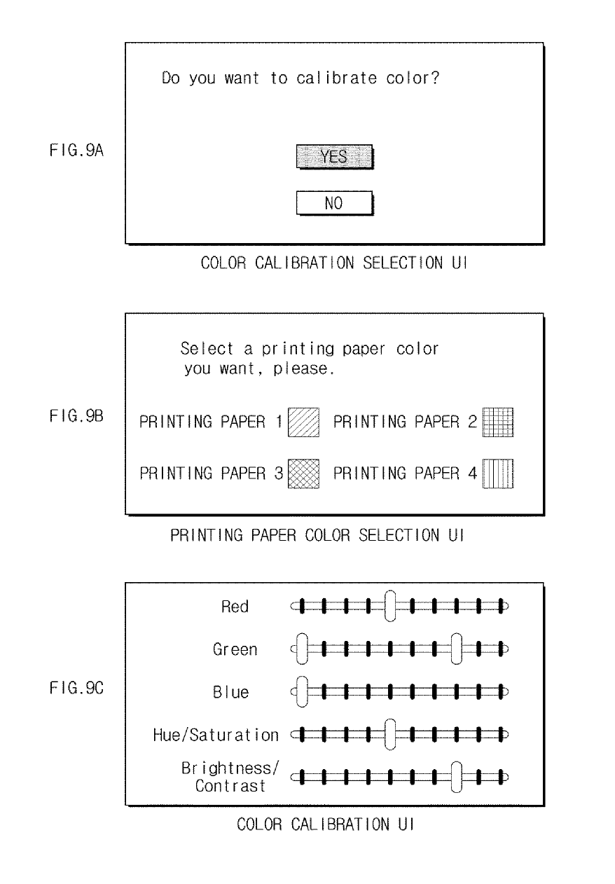

FIG. 1 shows an exterior of an image forming apparatus in accordance with an embodiment. Referring to FIG. 1, an image forming apparatus in accordance with an embodiment includes a main body 10, a document support 11, and a platen cover 12. The document support 11 is installed on an upper surface of the main body 10, and a manuscript, that is, a document to be read, is disposed on the document support 11. The platen cover 12 is mounted to be opened and closed on the main body 10, and has a structure by which the document support 11 is covered when the platen cover 12 is closed. An input 102 and a display 104 are installed at a side of the main body 10. The input 102 is installed in the form of a keypad, to receive a key input from a user for user authentication. The display 104 provides a user interface for user authentication. The display 104 may be provided in the form of a touch panel. Example embodiments of the user interface provided on the display 104 will be described below with reference to FIGS. 6 and 9.

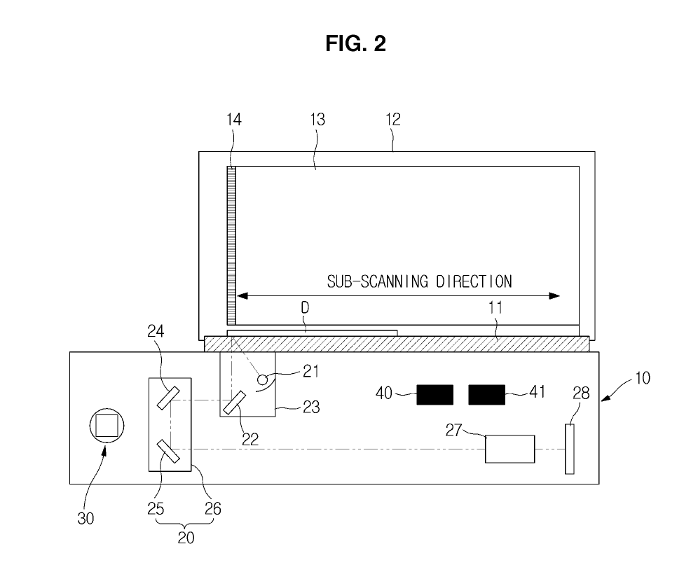

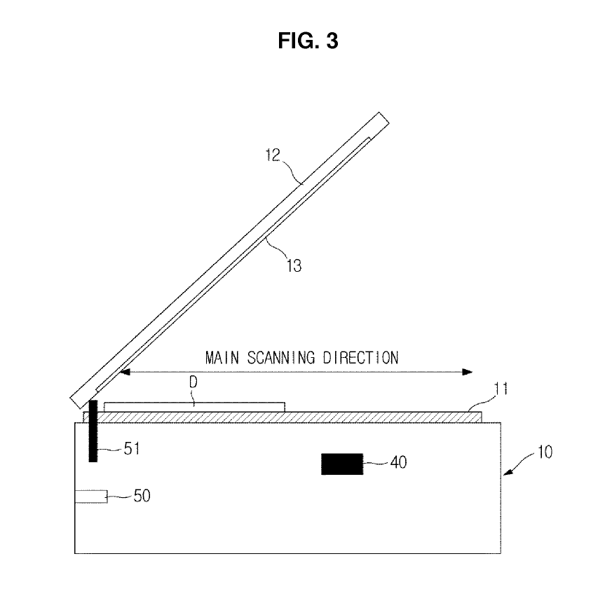

FIG. 2 is a front view of an image forming apparatus in accordance with an embodiment. FIG. 3 is a side view of an image forming apparatus in accordance with an embodiment. As shown in FIGS. 2 and 3, the main body 10 of an image forming apparatus in accordance with an embodiment includes a cover detector 50, a scanning unit 20, and a driving motor 30.

When the platen cover 12 is opened by more than a certain angle (e.g. 80°), the cover detector 50 outputs a signal corresponding thereto. In addition, when the platen cover 12 is closed after being open by more than a certain angle (e.g. 80°), the cover detector 50 outputs a signal corresponding thereto at the moment of closure. The cover detector 50 includes a light sensor 50 and a sensor flag 51. The sensor flag 51 is configured to be moved upward and downward by opening and closing of the platen cover 12, to be pressed by the platen cover 12 while the platen cover 12 is closed, and released when the platen cover 12 is opened. The closure of the platen cover 12 may be detected by a configuration in which light to the light sensor 50 is intercepted by the vertical movement of the sensor flag 51. A document size may be determined by detecting the width and length of a document D disposed on the document support 11 when the platen cover 12 is closed, which will be described later in detail.

The scanning unit 20 may be arranged at a back side of the document support 11, that is, an opposite side to a side at which the document D is arranged. The scanning unit 20 includes a light source 21 which emits light onto the document D, a plurality of mirrors 22, 24, and 25 which reflect light reflected from the document D irradiated with the light, a lens 27 collecting the light reflected by the mirrors 22, 24, and 25, and an image sensor 28 converting the light collected by the lens 27 into electrical signals. Accordingly, the reflected light from the document D is sequentially reflected by the first mirror 22, the second mirror 24, and the third mirror 25, is collected by the lens 27, and enters the image sensor 28 equipped on a substrate.

The light source 21 and the first mirror 22 are mounted on a first optical bench 23 which moves along the document support 11 in a sub-scanning direction. The second mirror 24 and the third mirror 25 are mounted on a second optical bench 26 which moves along the document support 11 in the sub-scanning direction. The first optical bench 23 and the second optical bench 26 move back and forth by the driving motor 30 in the sub-scanning direction. The light source 21 includes a lamp that emits light onto a document.

The image sensor 28 is fixed at a predetermined position. By the way, components of the scanning unit 20 can be integrally modularized and installed in such a way to move back and forth along the document support 11 in the sub-scanning direction. The image sensor 28 is formed of a charge coupled device (CCD) or a contact image sensor (CIS) which converts optical signals obtained by scanning a document to electrical signals. The image sensor 28 is arranged parallel to the document support 11 in a main scanning direction as a longitudinal direction. During reading of the document D, the image sensor 28 receives the reflected light from the document D irradiated by the light from the light source 21, and outputs a corresponding size of an electrical signal to the amount of the received light. The light radiated from the light source 21 is reflected by the document D. The reflected light is reflected by the first to third mirrors 22, 24, and 25 and collected by the lens 27, to be transferred to the image sensor 28. During reading of the document D, the first optical bench 23 and the second optical bench 26 are moved in the sub-scanning direction, such that the image sensor 28 generates image data corresponding to a document image. The image data generated by the image sensor 28 is transferred to a controller 60 which will be described later, and the image data is recognized as an image by the controller 60.

A document detecting sensor 40 serves to detect a length of a document placed on the document support 11 and thereby detect the presence of the document, and includes a reflective light sensor having a light emitting device emitting light toward the document support 11, and a light receiving device receiving a reflected light of the light.

When the document D is placed at a location at which the document detecting sensor 40 is installed, the light emitted from the light emitting device is reflected by the document D, and most amount of the light is received by the light receiving device. However, when no document D is placed at a location at which the document detecting sensor 40 is installed, since the light emitted from the light emitting device is not reflected by the document D and is dispersed in other directions than the light receiving device, the amount of light received by the light receiving device may decrease. The presence of the document D may be determined depending on the amount of the received light. In FIG. 2, although two document detecting sensors 40 are illustrated, three or more sensors may be arranged at a location corresponding to the length of the document D under the document support 11.

The platen cover 12 of the image forming apparatus in accordance with an embodiment may include a document pressing plate 13 which presses a document placed on the document support 11. The document pressing plate 13 is formed of a white sheet in order to process a margin of a document to be white during reading of the document. A mark pattern 14 in which a plurality of white bars and black bars are alternately printed is formed in the main scanning direction on the document pressing plate 13.

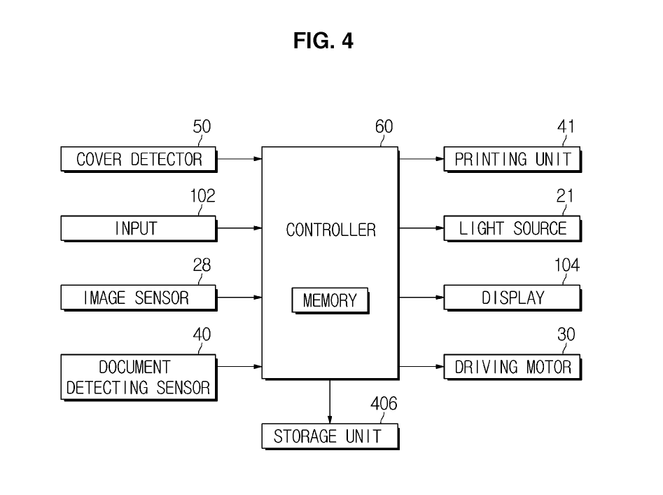

FIG. 4 is a diagram showing a control system of an image forming apparatus in accordance with an embodiment. Referring to FIG. 4, the image forming apparatus in accordance with an embodiment includes the controller 60 performing overall control operations.

In FIG. 4, a storage unit 406 stores software or firmware required for the controller 60 to control overall operations of the image forming apparatus, and especially obtains and stores whiteness data of a plurality of color printing media in advance. A method of obtaining the whiteness data of the plurality of color printing media is that, for example, a manufacturer of an image forming apparatus obtains and stores a whiteness (whiteness data) of each of various kinds of printing media in advance when fabricating the image forming apparatus, and helps a user who has purchased the image forming apparatus make use of the plurality of whiteness data pre-stored in the image forming apparatus for printing. Another method of obtaining whiteness data of a plurality of color printing media is that, for example, a user who has purchased an image forming apparatus directly inputs and stores a desired whiteness (whiteness data) of a printing medium, and makes use thereof. Of course, the two methods can be combined in one image forming apparatus. In addition, a printing unit 41 is for printing an image on a printing medium.

The controller 60 controls operations of the cover detector 50, the scanning unit 20, the driving motor 30, and the printing unit 41. The controller 60 perceives opening and closing of the platen cover 12 by detecting an operation of the cover detector 50. The controller 60 automatically determines a size of a document by detecting a width and length of the document, based on an output of the image sensor 28 of the scanning unit 20, and an output of the document detecting sensor 40. That is, in terms of the output of the image sensor 28, the controller 60 determines a width of a document according to a length of an area in which the same pixel values are consecutive in an image. In addition, in terms of the output of the document detecting sensor 40, the controller 60 determines a length of the document according to the presence of the document at a location at which the document detecting sensor 40 is positioned.

In this case, the controller 60 determines whether the platen cover 12 is closed, through the cover detector 50. When detecting closing of the platen cover 12, the controller 60 automatically moves the first optical bench 23 on which the light source 21 is disposed to a position corresponding to an area of the mark pattern 14 formed on the document pressing plate 13, by controlling the driving motor 30 which moves the first optical bench 23 and the second optical bench 26 of the scanning unit 20 in the sub-scanning direction. Then the controller 60 generates an image for the area at which the mark pattern 14 is formed, and determines the width of the document depending on a length of an area in which the same pixel values are consecutive in the generated image. After determining the width of the document, the first optical bench 23 returns to an original position. In this case, as described above, when the location of a home position is the same as a location corresponding to the area at which the mark pattern 14 is formed, there is no need to move the first optical bench 23.

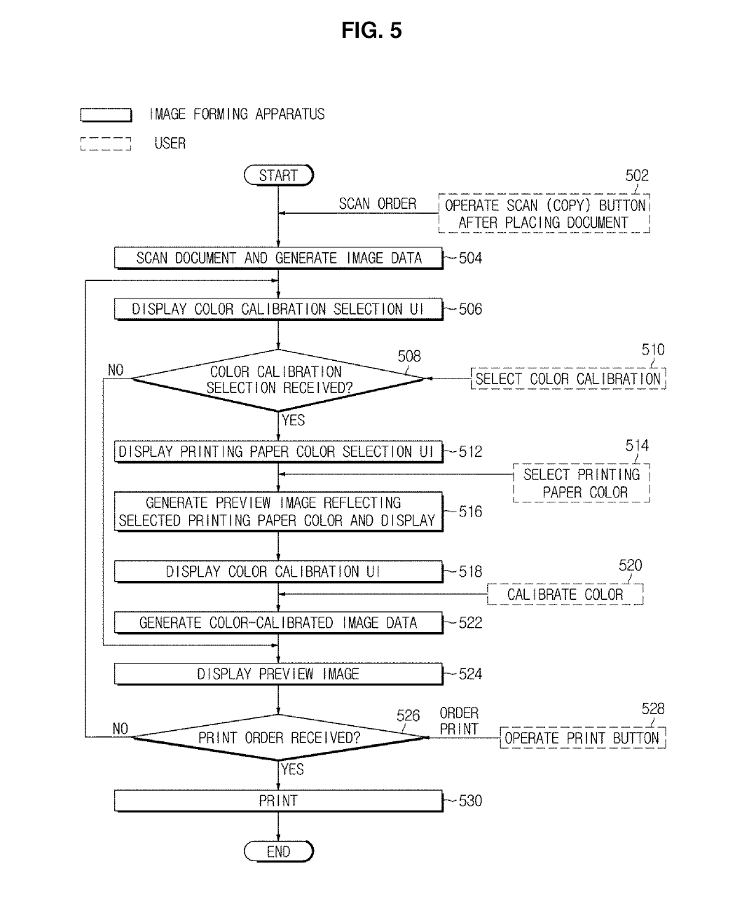

FIG. 5 is a diagram showing a first example of a control method of generating a preview picture reflecting a color of a printing medium, in an image forming apparatus in accordance with an embodiment. FIG. 6 is a diagram showing user interfaces UIs displayed on a display while performing the control method of FIG. 5. In FIG. 5, solid-line blocks represent processes performed by the controller 60 of the image forming apparatus, and dotted-line blocks represent processes intervened by a user.

As shown in FIG. 5, when the user places a document on the document support 11 of the image forming apparatus, and then operates a scan button or a print button formed in the input 102, a signal corresponding to a scan order is generated and transferred to the controller 60 (502). The controller 60 which has received the scan order, operates the scanning unit 20 to scan the document, and generates image data as a result (504). The controller 60 displays a color calibration selection user interface (UI) on the display 104 in order to ask whether the user performs color calibration on the generated image data or not, and receive the user's choice therebetween (506). Here, the color calibration selection UI displayed on the display 104 is shown in FIG. 6A. As shown in FIG. 6A, a message of asking whether the user performs the color calibration, and selection buttons, such as YES or NO, to receive the user's choice therebetween, may be displayed. The user may select what he/she wants between YES and NO by operating a direction key or a navigation dial formed in the input 102 of the image forming apparatus.

When the color calibration is selected by the user (YES in process 508) (510), the controller 60 displays a printing media color selection UI on the display 104 in order for the user to select a color of a printing medium (512). Here, the color of the printing medium is a color of a surface of the printing medium on which an image is to be printed. Here, the printing media color selection UI displayed on the display 104 is shown in FIG. 6B. As shown in FIG. 6B, a message encouraging the user to select a desired color of the printing medium, and a plurality of color samples 602 that help the user select a color corresponding to the color of the printing medium, are displayed on the display 104. The user may select a desired color by operating a direction key or a navigation dial formed in the input 102 of the image forming apparatus. When the color selection is completed by the user, a color value of the selected color is transferred to the controller 60. Then, the controller 60 receives the color value to recognize the color of the printing medium which the user has selected. Since the color selection is for reflecting the color of the printing medium, it is desirable for the user to select a color corresponding to the color of the printing medium on which a scanned image is to be printed.

When the printing media color selection is completed by the user (514), the controller 60 performs a color calibration (a first color calibration) reflecting the color of the printing medium selected by the user, and generates a color-calibrated preview image to be displayed on the display 104 (516). For example, when the color of the printing medium is yellow and an image having a different color is printed on the printing medium, the yellow color of the printing medium affects the color of the image which is to be printed. Therefore, the image may be printed to have a different color from when the image is printed on a white printing medium. Accordingly, if the preview image is implemented in consideration of the white printing medium even though the color of printing medium is yellow, the preview image may have a different color from when it is printed on the yellow printing medium. In this case, the user needs to calibrate the image data and proceed with a new printing job, resulting in a waste of time and printing media. However, as shown in an embodiment, if the preview image is implemented reflecting the color of the printing medium (e.g. yellow) on which the image is actually printed, the color of the preview image and the color of printed output will be the same or very similar. Therefore, since there is no need to perform a new printing job, a waste of time and printing media can be prevented.

In addition, after displaying the preview image reflecting the color of the printing medium, the controller 60 displays a color calibration UI on the display 104 in order for the user to perform color calibration (518). Here, the color calibration UI displayed on the display 104 is shown in FIG. 6C. The controller 60, as shown in FIG. 6C, displays at least one color calibration option on the display 104 in order for the user to directly perform the color calibration on the image data. The color calibration option displayed on the display 104 may include an option of controlling three primary colors consisting of red, green, and blue, an option of controlling hue and saturation, and an option of controlling brightness and contrast. Further, other additional options can be included for the calibration of the image data. The user selects a desired option by operating a direction key or a navigation dial included in the input 102 of the image forming apparatus, and performs the color calibration (a second calibration) by adjusting a value thereof (520).

The controller 60 generates a calibrated image data reflecting the color calibration (the second calibration) by the user, in addition to the color calibration (the first calibration) reflecting the color of the printing medium to the image data obtained by scanning the document (522). Further, the controller 60 allows the user to check the preview image by displaying the preview image using the calibrated image data on the display 104 (524). When the preview image reaches a desired level, the user may generate a print order by operating a print button of the input 102 (528). If the print order is generated (YES in process 526), the controller 60 operates the printing unit 41 to print an image of the color-calibrated image data (530). On the contrary, if no print order occurs (No in process 526), the process returns to the process of displaying the color calibration selection UI (506) in order for the user to perform the color calibration once again.

During the above described process of receiving the color calibration selection (508), if no color calibration selection is performed by the user (NO in process 508), the controller 60 does not perform the color calibration on the resulting image data. Instead, the controller 60 directly displays the preview image on the display 104 using the image data, and thereby the user can check the preview image (524). Next, depending on whether the print order occurs or not, the controller 60 operates the printing unit 41 to print an image of the image data which is not color-calibrated (YES in process 526), or returns to the process of displaying the color calibration selection UI (506) in order for the user to perform color calibration (NO in process 526).

The image forming apparatus in accordance with an embodiment may scan a specific printing medium which is frequently used, to obtain and store the whiteness data of the printing medium in advance. Then, the whiteness data of the printing medium may be output directly to apply to the color calibration when performing a printing job using the printing medium, and thereby the color calibration reflecting the color of the printing medium may be done more conveniently. The principle of the color calibration using whiteness data of a printing medium is as follows.

In the image sensor 28 included in the scanning unit 20, a scanned CMYK value of a printing medium is interpreted as an RGB value and converted to a CIE XYZ value, that is an independent color space of the scanning unit 20. Here, the XYZ value is represented by X1, Y1, and Z1, and XPCS1, YPCS1, and ZPCS1 values in the color space can be obtained by <Formula 1>.

XPCS_{—}S=X1*XWPD50/XWP1 <Formula 1>

YPSC_{—}S=Y1*YWPD50/YWP1

ZPCS_{—}S=Z1*ZWPD50/ZWP1

Here, XWPD50, YWPD50, and ZWPD50 represent whiteness at a color temperature of 5000K. Whiteness of a specific printing medium is obtained from image data obtained by scanning the printing medium.

(XWPD50=0.9642, YWPD50=1.0000, ZWPD50=0.8249)

XWP1, YWP1, and ZWP1 represent whiteness of a printing medium defined in an ICC profile of the scanning unit 20.

XPCS2, YPCS2, and ZPCS2 values of the CIE XYZ color processed by the printing unit 41, in a PCS space can be obtained by <Formula 2>.

XPCS_{—}P=X2*XWPD50/XWP2 <Formula 2>

YPCS_{—}P=Y2*YWPD50/YWP2

ZPCS_{—}P=Z2*ZWPD50/ZWP2

XWP50, YWP50, and ZWP50 represent whiteness at a color temperature of 5000K, and XWP2, YWP2, and ZWP2 represent whiteness of a printing medium, defined by an ICC profile of the printing unit 41.

Here, since the values in the color space are the same in the scanning unit 20 and the printing unit 41,

XPCS_S=XPCS_P, YPCS_S=YPCS_P, ZPCS_S=ZPCS_P

Accordingly, <Formula 3> is derived.

X2=X1*XWP2/XWP1 (2?) <Formula 3>

Y2=Y1*YWP2/YWP2

Z2=Z1*ZWP2/ZWP2

Here, <Formula 4> is derived from <Formula 3>.

XWP2′=XWP2*(XWPP/XWP1) <Formula 4>

YWP2′=YWP2*(YWPP/YWP1)

ZWP2′=ZWP2*(ZWPP/ZWP1)

(Here, XWP1, YWP1, and ZWP1: whiteness defined by an ICC profile of a scanning unit, XWP2, YWP2, and ZWP2: a whiteness defined by an ICC profile of a printing unit, XWPP, YWPP, and ZWPP: a whiteness of a printing medium scanned by a scanning unit)

XWP′, YWP′, and ZWP′ obtained by <Formula 4> are used as a whiteness to be converted into the PCS space of the printing unit 41. XPCS, YPCS, and ZPCS values, which are color space values of an image to be printed by the printing unit 41 can be obtained from the calculated XW2′, YW2′, and ZW2′ as follows.

XPCS=X*XWPD50/XWP2′ <Formula 5>

YPCS=Y*YWPD50/YWP2′

ZPCS=Z*ZWPD50/ZWP2′

(Here, X, Y, and Z: a color of an input image, XWPD50, YWPD50, and ZWPD50: a whiteness point defined at a color temperature of 5000K)

By converting the values from the PCS values to CMYK values through the ICC profile of the printing unit 41, the image may be printed by the printing unit 41.

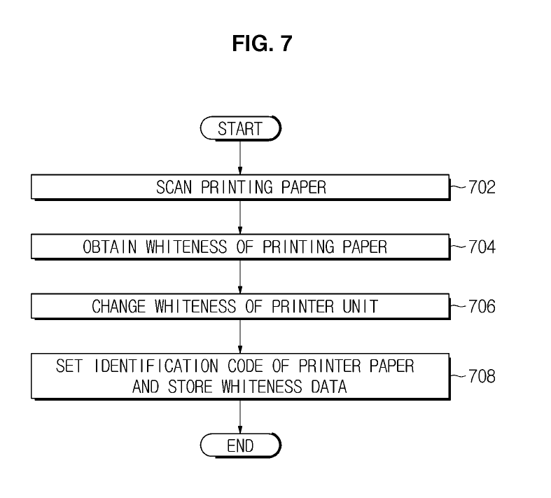

FIG. 7 is a diagram showing a method of obtaining whiteness data in image forming apparatus in accordance with an embodiment. As shown in FIG. 7, the user scans a specific printing medium (e.g. a printing medium expected to be frequently used) through the scanning unit 20 (702). Here, the controller 60 obtains a whiteness of the printing medium through the image sensor 28 of the scanning unit 20 (704).

In addition, the controller 60 converts a whiteness of the printing unit 41 to be suitable for the printing medium, with reference to the whiteness of the printing medium (706). Here, the conversion of the whiteness of the printing unit 41 is for obtaining a printed output close to a desired color regardless of the color of the printing medium by calibrating the whiteness if the printing medium has a color other than white. The whiteness of the printing unit 41 converted in this way is used for color calibration of a preview image, and color calibration at an actual printing operation.

Such a relationship between a specific printing medium and a corresponding whiteness thereto is stored in the storage unit 406, etc. in forms of a look-up table (708). That is, if at least one printing medium is scanned and a corresponding whiteness thereto is obtained, an identification number (or name) for identifying the printing medium is specified, the color is recorded, and the whiteness of the printing medium is stored. Accordingly, the user can check and select the identification number (or name) of the printing medium displayed on the display 104, and the corresponding color, and the controller 60 performs color calibration reflecting the whiteness of the printing medium that the user has selected.

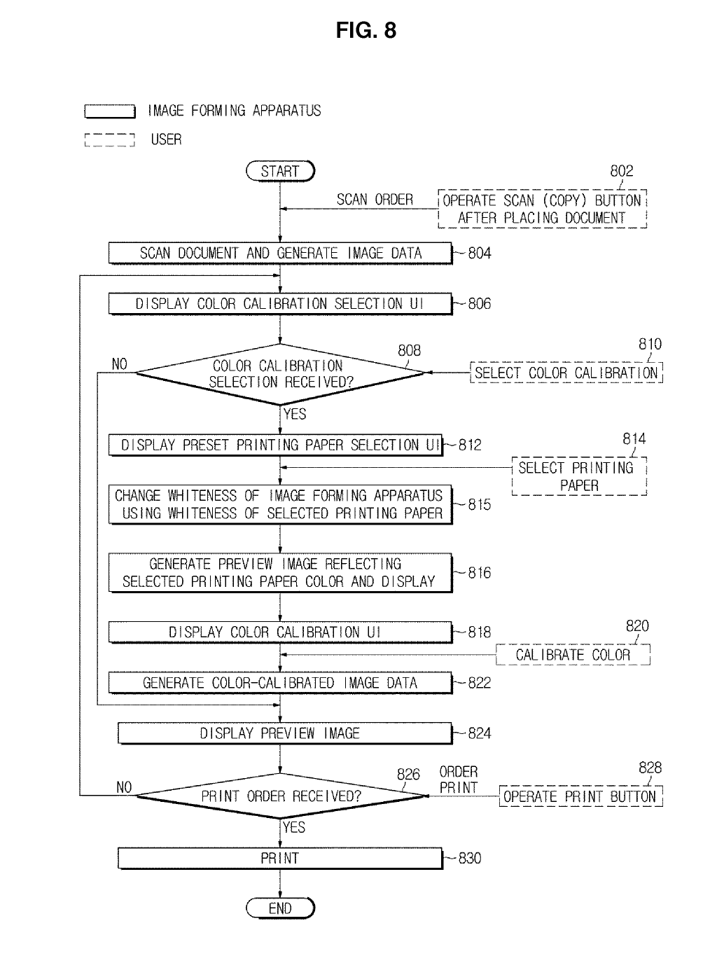

FIG. 8 is a diagram showing a second example of a control method of generating a preview picture reflecting a color of a printing medium, in an image forming apparatus in accordance with an embodiment. FIG. 9 is a diagram showing user interfaces UI displayed on a display while performing the control method of FIG. 8. In FIG. 8, solid-line blocks represent processes performed by the controller 60 of the image forming apparatus, and dotted-line blocks represent processes intervened by a user.

As shown in FIG. 8, when the user places a document on the document support 11 of the image forming apparatus and then operates a scan button or a print button included on the input 102, a signal corresponding to a scan order is generated and transferred to the controller 60 (802). The controller 60 which has received the scan order, operates the scanning unit 20 to scan the document, and generates image data as a result (804). The controller 60 displays a color calibration selection UI on the display 104 in order to ask whether the user performs color calibration on the generated image data or not, and receive the user's choice therebetween (806). Here, the color calibration selection UI displayed on the display 104 is shown in FIG. 9A. As shown in FIG. 9A, a message of asking whether the user performs the color calibration or not, and selection buttons, such as YES and NO, to receive the user's choice therebetween, may be displayed. The user may select what he/she wants between YES and NO by operating a direction key or a navigation dial included in the input 102 of the image forming apparatus.

When the color calibration is selected by the user (YES in process 808) (810), the controller 60 displays a printing media selection UI that helps the user select a color of the printing medium on the display 104 (812), in order to withdraw the pre-stored whiteness data of the printing medium. Here, the color of the printing medium is a color of a surface on which an image of the printing medium is to be printed. The UI displayed on the display 104 is for checking and selecting a unique identification code (a number or a name) and a corresponding color thereto, as described above with reference to FIG. 7. Here, the printing media selection UI displayed on the display 104 is shown in FIG. 9B. As shown in FIG. 9B, by displaying a message of helping the user select a preferred printing medium, and the unique identification code (a number or a name) and corresponding color thereto on the display 104, the user can check and select thereof. The user may select a desired printing medium (or its color) by operating a direction key or a navigation dial included in the input 102 of the image forming apparatus. When the selection of the printing medium (or its color) is completed by the user, a color value of the selected printing medium (or its color) is transferred to the controller 60, and the controller 60 receives the color value and recognizes the selected printing medium (or its color) the user has selected. When the color of the printing medium is selected (814), as described above with reference to FIG. 7, the whiteness of the printing unit 41 of the image forming apparatus is changed to match the printing medium with reference to the whiteness of the printing medium selected by the user (815).

When the printing medium is selected, and the whiteness of the printing unit 41 is changed in such a way that the whiteness of the printing medium is reflected, the controller 60 performs color calibration (a first color calibration) reflecting the whiteness of the printing medium selected by the user, and generates a color-calibrated preview image to be displayed on the display 104 (816). For example, when the color of the printing medium is yellow and an image having a different color is printed on the printing medium, the yellow color of the printing medium affects the color of the image which is to be printed. Therefore, the image may be printed to have a different color from when the image is printed on a white printing medium. Accordingly, if the preview image is implemented in consideration of the white printing medium even though the color of printing medium is yellow, the preview image may have a different color from when it is printed on the yellow printing medium. In this case, the user needs to calibrate the image data and proceed with a new printing job, resulting in a waste of time and printing media. However, as shown in exemplary embodiment, if the preview image is implemented reflecting the color of the printing medium (e.g. yellow) on which the image is actually printed, the color of the preview image and the color of the printed output will be the same or very similar. Therefore, since there is no need to perform a new printing job, a waste of time and printing media can be prevented.

In addition, after displaying the preview image reflecting the color of the printing medium, the controller 60 displays a color calibration UI on the display 104 in order for the user to perform a color calibration (818). Here, the color calibration UI displayed on the display 104 is shown in FIG. 9C. The controller 60, as shown in FIG. 9C, displays at least one color calibration option on the display 104 in order for the user to directly perform further color calibration on the image data. The color calibration option displayed on the display 104 may include an option of controlling three primary colors consisting of red R, green G, and blue B, an option of controlling hue and saturation, and an option of controlling brightness and contrast. In addition, other additional options may be included for the calibration of the image data. The user selects a desired option by operating a direction key or a navigation dial included in the input 102 of the image forming apparatus, and performs the color calibration (a second calibration) by adjusting a value of the option (820).

The controller 60 generates a calibrated image data reflecting the color calibration by the user, in addition to the color calibration (the first calibration) reflecting the color of the printing medium to the image data obtained by scanning the document (822). Further, the controller 60 allows the user to check the preview image by displaying the preview image using the calibrated image data on the display 104 (824). When the preview image reaches a desired level, the user may generate a print order by operating a print button of the input 102 (828). If the print order is generated (YES in process 826), the controller 60 operates the printing unit 41 to print an image of the color-calibrated image data (830). On the contrary, if no print order occurs (No in process 826), the process returns to the process of displaying the color calibration selection UI (806) in order for the user to perform the color calibration once again.

During the above described process of receiving the color calibration selection (808), if no color calibration selection is performed by the user (NO in process 808), the controller 60 does not perform the color calibration on the resulting image data. Instead, the controller 60 directly displays the preview image on the display 104 using the image data, and thereby the user can check the preview image (824). Next, depending on whether the print order occurs or not, the controller 60 operates the printing unit 41 to print an image of the image data which is not color-calibrated (YES in process 826), or returns to the process of displaying the color calibration selection UI (806) in order for the user to perform the color calibration (NO in process 826).

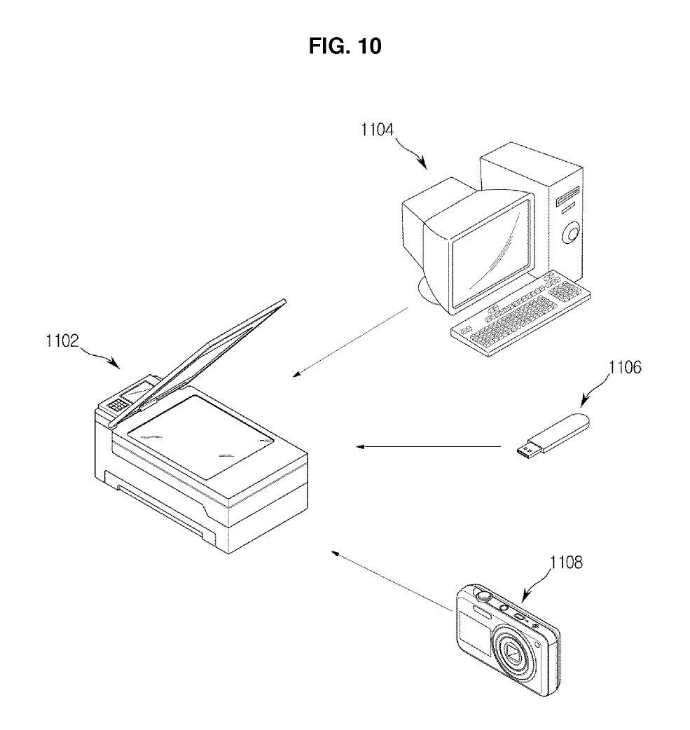

FIG. 10 is a diagram showing another method of receiving image data in an image forming apparatus in accordance with an embodiment. In the image forming apparatus shown in FIGS. 1 to 9, image data is obtained by scanning a document through the scanning unit 20. However, as shown in FIG. 10, color calibration of a preview image in consideration of a color of a printing medium as shown in FIGS. 1 to 9 is fully possible, even when printing image data directly received from a computer 1104 connected to an image forming apparatus 1102 to communicate, a universal serial bus (USB) memory 1106 connected to communicate through a USB port, or a digital camera 1108, etc. connected through a communication cable or a wireless communication such as Bluetooth, etc.,

According to one or more embodiments, an image forming apparatus by which an image is printed on a printing medium provides a preview image color-calibrated according to a color of the printing medium on which the image is to be printed. Thus, since a preview picture is the same as a result printed on the real printing medium even when the printing medium is a color printing medium, confusion of the user, duplication of printing jobs, and waste of printing media may be prevented.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A method of controlling an image forming apparatus, comprising:
receiving image data;
receiving color information of a printing medium which is to be used in printing of the image data; and
performing a first color calibration on the image data, which reflects the color information of the printing medium.

2. The method according to claim 1, further comprising displaying a preview picture of the color-calibrated image data on a display.

3. The method according to claim 1, further comprising displaying a user interface configured to receive the color information of the printing medium on a display.

4. The method according to claim 3, wherein the user interface displays a plurality of color samples on the display, in order for a user to select a color corresponding to a color of the printing medium from among the color samples.

5. The method according to claim 3, wherein the user interface displays a unique identification code of at least one printing medium, and a corresponding color on the display.

6. The method according to claim 5, wherein:
when the at least one printing medium is selected, the preview picture is generated reflecting whiteness data of the at least one printing medium, and
wherein the whiteness data of the at least one printing medium has been stored in the image forming apparatus.

7. The method according to claim 6, further comprising obtaining the whiteness data of the at least one printing medium in advance, to be stored in the image forming apparatus.

8. The method according to claim 6, further comprising receiving the whiteness data of the at least one printing medium from the user, to be stored in the image forming apparatus.

9. The method according to claim 6, wherein the whiteness data of the at least one printing medium is obtained by pre-scanning the at least one printing medium.

10. The method according to claim 9, further comprising converting a color space of the image data to a color space of a printing unit by which an image is to be formed on the printing medium, reflecting the whiteness data.

11. The method according to claim 1, further comprising:
displaying a user interface including at least one color calibration option on the display; and
allowing a user to perform a second color calibration on the image data shown in the preview picture by directly adjusting a value of the at least one color calibration option.

12. The method according to claim 11, wherein the color calibration option of the user interface includes an option of controlling three primary colors consisting of red (R), green (G), and blue (B).

13. An image forming apparatus, comprising:
an input device which receives color information of a printing medium which is to be used in printing of image data; and
a controller which performs a first color calibration on the image data, which reflects the color information of the printing medium received from the input device.

14. The image forming apparatus according to claim 13, further comprising a display which displays a preview picture of the color-calibrated image data.

15. The image forming apparatus according to claim 13, wherein the input device is a display which displays a user interface for receiving the color information of the printing medium.

16. The image forming apparatus according to claim 15, wherein the user interface displays a plurality of color samples on the display, in order for a user to select a color corresponding to a color of the printing medium.

17. The image forming apparatus according to claim 15, wherein the user interface displays a unique identification code of at least one printing medium, and a corresponding color on the display.

18. The image forming apparatus according to claim 17, wherein when the at least one printing medium is selected, the preview picture is generated reflecting whiteness data of the at least one printing medium.

19. The image forming apparatus according to claim 18, wherein the whiteness data of the at least one printing medium is obtained by pre-scanning the at least one printing medium.

20. The image forming apparatus according to claim 18, further comprising obtaining the whiteness data of the at least one printing medium in advance, to be stored in the image forming apparatus.

21. The image forming apparatus according to claim 18, further comprising receiving the whiteness data of the at least one printing medium from a user, to be stored in the image forming apparatus.

22. The image forming apparatus according to claim 18, further comprising converting a color space of the image data to a color space of a printing unit by which an image is to be formed on the printing medium, reflecting the whiteness data.

23. The image forming apparatus according to claim 13, further comprising:
displaying a user interface including at least one color calibration option on the display; and
allowing a user to perform a second color calibration on the image data shown in the preview picture by directly adjusting a value of the at least one color calibration option.

24. The image forming apparatus according to claim 23, wherein the color calibration option of the user display includes an option of controlling three primary colors consisting of red (R), green (G), and blue (B).

25. A method of controlling an image forming apparatus, comprising:
receiving image data which is to be printed;
displaying a user interface including a plurality of color samples on a display, in order for a user to select a color corresponding to a color of a printing medium;
receiving color information of the printing medium which is to be used in printing of the image data through the user interface; and
performing a first color calibration on the image data, which reflects the color information of the printing medium.

26. The method according to claim 25, further comprising displaying a preview picture of the color-calibrated image data on the display.

27. The method according to claim 25, further comprising displaying the user interface configured to receive the color information of the printing medium on the display.

28. The method according to claim 25, further comprising:
displaying a user interface including at least one color calibration option on the display; and
allowing the user to directly perform a second color calibration on the image data shown in the preview picture by directly adjusting a value of the at least one color calibration option.

29. A method of controlling an image forming apparatus, comprising:
obtaining whiteness data of at least one printing medium by scanning the at least one printing medium;
storing interrelationships of a unique identification code of the at least one printing medium, a corresponding color, and whiteness data;
receiving image data;
receiving color information of the printing medium which is to be used in printing of the image data, through selection of the unique identification code of the at least one printing medium;
converting a color space of the image data to a color space of a printing unit by which an image is to be formed on the printing medium, which reflects the obtained whiteness data of the at least one printing medium; and
performing a first color calibration on the image data, which reflects the converted color space.

30. The method according to claim 29, further comprising displaying a preview picture of the color-calibrated image data on a display.

31. The method according to claim 29, further comprising displaying a user interface f configured to receive the color information of the printing medium on a display.

32. The method according to claim 29, further comprising:
displaying a user interface including at least one color calibration option on a display; and
allowing a user to directly perform a second color calibration on the image data shown in the preview picture by directly adjusting a value of the at least one color calibration option.

33. The method according to claim 29, further comprising obtaining the whiteness data of the at least one printing medium in advance, to be stored in the image forming apparatus.

34. The method according to claim 29, further comprising receiving the whiteness data of the at least one printing medium from a user, to be stored in the image forming apparatus.
